(19) United States
(12) Patent Application Publication
(10) Pub. No.: US 2007/0104360 A1
(43) Pub. Date: May 10, 2007

(54) System and method for capturing 3D face

(75) Inventors: Po Wei Huang, Hsinchu City (TW); Wen Kuo Lin, Taipei (TW)

Correspondence Address: TROXELL LAW OFFICE PLLC, SUITE 1404, 5205 LEESBURG PIKE, FALLS CHURCH, VA, 22041, US

(73) Assignee: Smedia Technology Corporation

(21) Appl. No.: 11/269,735

(22) Filed: Nov. 9, 2005

(51) Int. Cl. G06K 9/00; G09G 5/00

(52) U.S. Cl. 382/154; 345/582

(57) ABSTRACT

A system and method are disclosed, wherein the system for capturing 3D face includes following elements: (1) a digital image system, for acquiring a photo; (2) a 3D graphic processor, for manipulating image data of the photo, rendering the image data to a 3D graph or storing the image data and the 3D graph; and (3) a display device, for displaying the image data or the 3D graph; the method is characterized by manipulating image data by a 3D graphic processor, and obtaining better quality without using a powerful CPU.

### BACKGROUND OF THE INVENTION

1. Field of the Invention

The present invention relates to manipulating 3D images, and more particularly, to a system and method for capturing 3D face. The disclosure of the present invention can be applied to a portable hand-help device, such as, but not limited to, Digital Still Camera (DSC), Digital Video (DV), Personal Digital Assistant (PDA), mobile electronic device, 3G mobile phone, cellular phone or smart phone.

2. Description of the Prior Art

As portable electronic devices are used widely, interesting applications and games embedded in the electronic devices are getting more popular. Nowadays the portable electronic devices, such as mobile phone and PDA (personal digital assistant), are very often incorporated with a digital image capturing system. Therefore, a sort of applications not limited to the conventional photo acquisition has become more and more popular. One of those applications is to take a human face image and then to merge the face image with a 3D (3-dimension) model used for an interactive game or for a caller identification.

FIG. 1 is a block diagram of a conventional system for capturing 3D face. As shown in FIG. 1, the system 10 comprises a digital image system 12, a central processing unit (CPU) 14, a display device 16 and a storage device 18. The digital image system 12 is used for acquiring a photo 20. The central processing unit (CPU) 14 is used for manipulating image data 22 of the photo 20. The display device 16 is used for displaying images acquired and manipulated. The storage device 18 is used for storing temporary image data and the final modified 3D image data.

A method for capturing 3D face performed by the conventional system 10 is shown in FIG. 2. Firstly, in step S10, a 3D face model is selected by a user. In step S12, as shown in FIG. 3, a rough outline 32 of the 3D face model selected is loaded and displayed on a preview display 30. An example of the rough outline is shown in FIG. 3.

In step S14, a camera is pointed to a human object by the user. In step S16, the camera is moved to place the human face within the rough outline of the model. In step S18, a photo is taken when the human face is placed within the outline. In step S20, the photo taken is post-manipulated, such as scrolling and size changing, to best fitting the outline. However, depending on the performance of the CPU, the manipulations of the photo can not be applicable if a low performance CPU is used. In step S22, the photo region inside the outline is cropped and saved as a texture. Finally, in step S24, the texture is mapped to the 3D face model.

Nevertheless, the conventional system for acquiring 3D face has several disadvantages. First, in order to perform 3D image data manipulation, the system will require a high performance CPU which adversely increases the implementation costs and power consumptions. Second, even though a high performance CPU is exploited, it can not deplete its entire power only for the 3D application because the CPU is for general purposes and still needs to handle tasks, such as maintenance of operating system, management of file system or handshaking of communication. Consequently, a high quality 3D face capturing system can be achieved as the requirements of complexity to be limited to a level that can be performed by the conventional CPU system. Third, due to the limitations of CPU processing power in the hand-held device, the post-processing for taking the photo is limited to scrolling and size changing that can not produce a texture best match to the model outline. As a result, the texture mapping for the 3D face model can not be accurately generated and the user needs to acquire another human face photo for correcting the mapping error which results in a time-consuming process. Finally, even, the face texture mapping can be perfectly performed, due to the power computations of the general purpose CPU, the polygon rate and the displaying frame rate are both constrained; therefore, the final quality is compromised.

### SUMMARY OF THE INVENTION

An objective of the present invention is to solve the above-mentioned problems and to provide a system and method for capturing 3D face that has much better quality and does not require a powerful CPU, characterized by captured images being manipulated by a 3D graphic processor.

The present invention achieves the above-indicated objective by providing a system for capturing 3D face. The system for capturing 3D face includes following elements: (1) a digital image system, for acquiring a photo; (2) a 3D graphic processor, for manipulating image data of the photo, rendering the image data to a 3D graph or storing the image data and the 3D graph; and (3) a display device, for displaying the image data or the 3D graph.

According to another aspect of the present invention, a method for capturing 3D face first selects a 3D face model for a living object. Next, a number of acquiring angles of the 3D face model are decided. Next, a rough outline of the model selected is loaded and displayed on a display. Next, a camera of a hand-held device is pointed to the living object. Next, the camera of the hand-held device is moved to place the object face within the rough outline displayed on the screen. Next, a photo of the face is taken and saved when the face is placed within the outline. Next, the photo of a first acquiring angle is loaded. Next, the photo of a first acquiring angle is displayed on the screen concurrently with a detailed 3D face model outline. Next, an interactive displacement, rotation or zoom is performed to match the face photo to the model outline. Next, the photo within the outline is cropped and saved as the texture of the current angle when matching the outline and key registration points. Finally, the 3D graphic processor maps the saved texture image(s) to the 3D face model.

The following detailed description, given by way of example and not intended to limit the invention solely to the embodiments described herein, will best be understood in conjunction with the accompanying drawings.

### BRIEF DESCRIPTION OF THE DRAWINGS

FIG. 1 is a block diagram of a conventional system for capturing 3D face.

FIG. 2 is a flow chart showing the steps for capturing 3D face performed by the conventional system.

FIG. 3 is an example of a rough outline for a 3D face model.

FIG. 4 is a block diagram of a system for capturing 3D face of the present invention.

FIGS. 5A and 5B are a flow chart showing the steps for a method for capturing 3D face of the present invention.

FIG. 6 is an example of a detailed 3D face model outline for a 3D face model.

FIG. 7 is a conceptual diagram for illustrating a displacement, rotation, and zoom that are performed by a 3D graphic processor of the present invention.

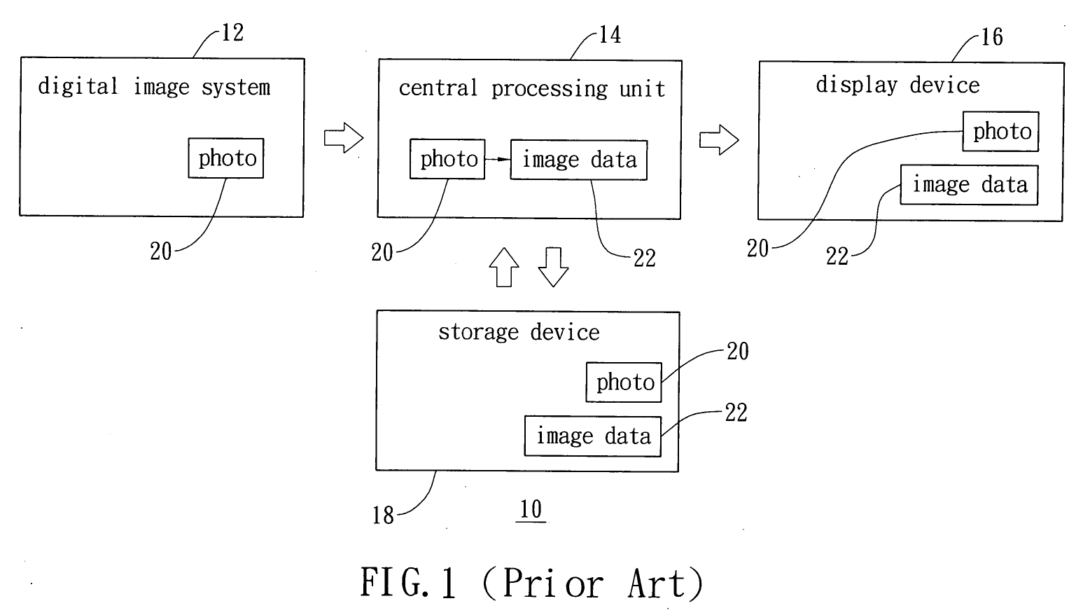

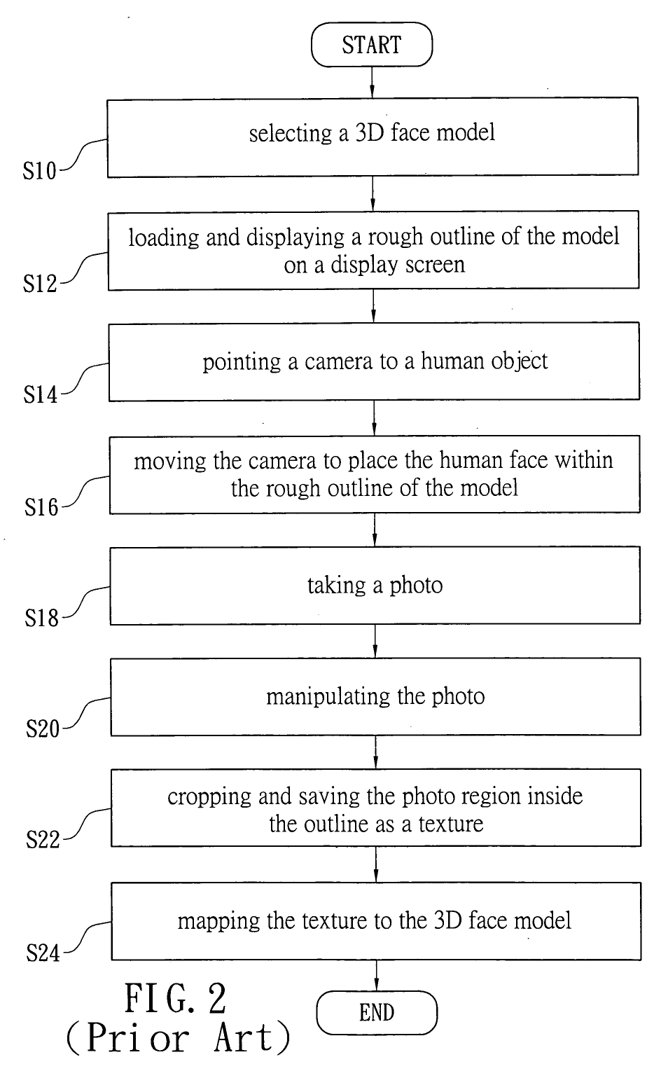

### DETAILED DESCRIPTION OF THE PREFERRED EMBODIMENTS

The present invention discloses a system and method for capturing 3D face that is applicable to a portable hand-help device, such as, but not limited to, Digital Still Camera (DSC), Digital Video (DV), Personal Digital Assistant (PDA), mobile electronic device, 3G mobile phone, cellular phone or smart phone.

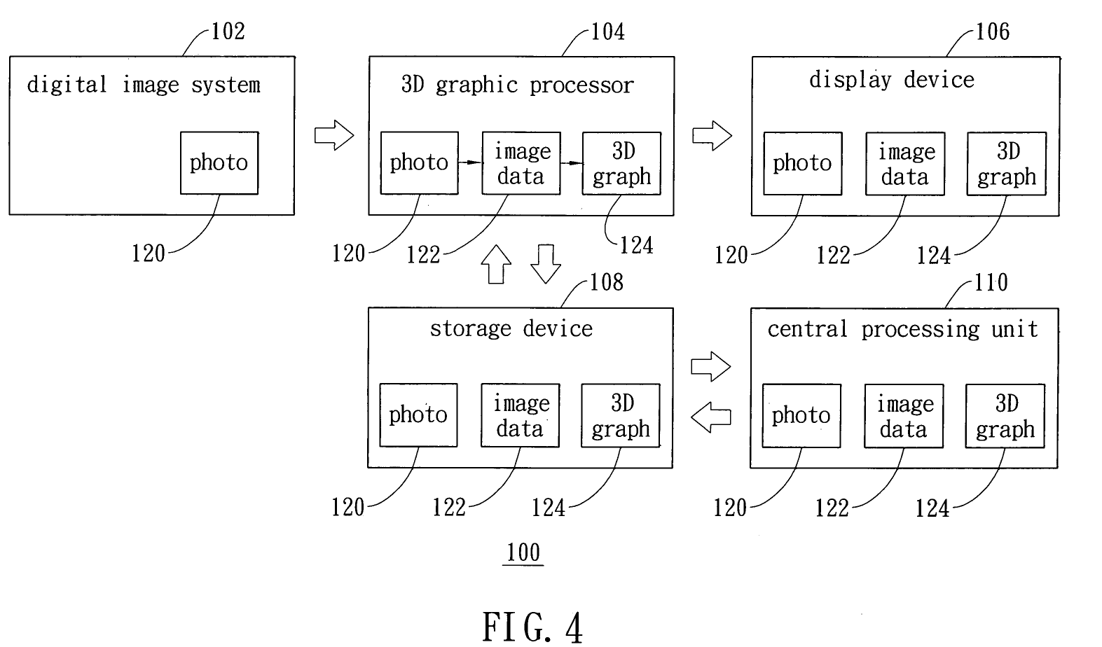

FIG. 4 is a block diagram of a system for capturing 3D face of the present invention. As shown in FIG. 4, the system 100 comprises a digital image system 102, a 3D graphic processor 104, a display device 106, a storage device 108 and a central processing unit (CPU) 110.

The digital image system 102 is used for acquiring a photo 120. The 3D graphic processor 104 is used for manipulating image data 122 of the photo 120, rendering the image data 122 to a 3D graph 124 or storing the photo 120, the image data 122 and the 3D graph 124, as shown in FIG. 4. The display device 106 is used for displaying the photo 120, the image data 122 or the 3D graph 124. The storage device 108 can be used for storing the photo 120, the image data 122 and the 3D graph 124. The central processing unit 110 is used for coordinating the system 100.

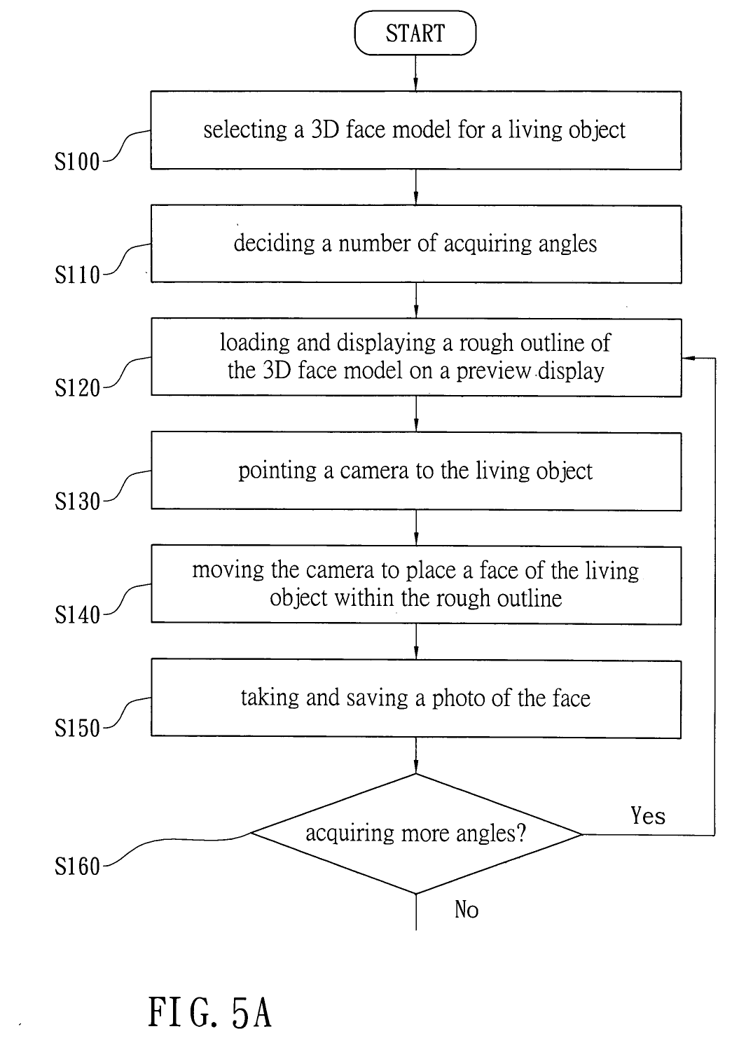

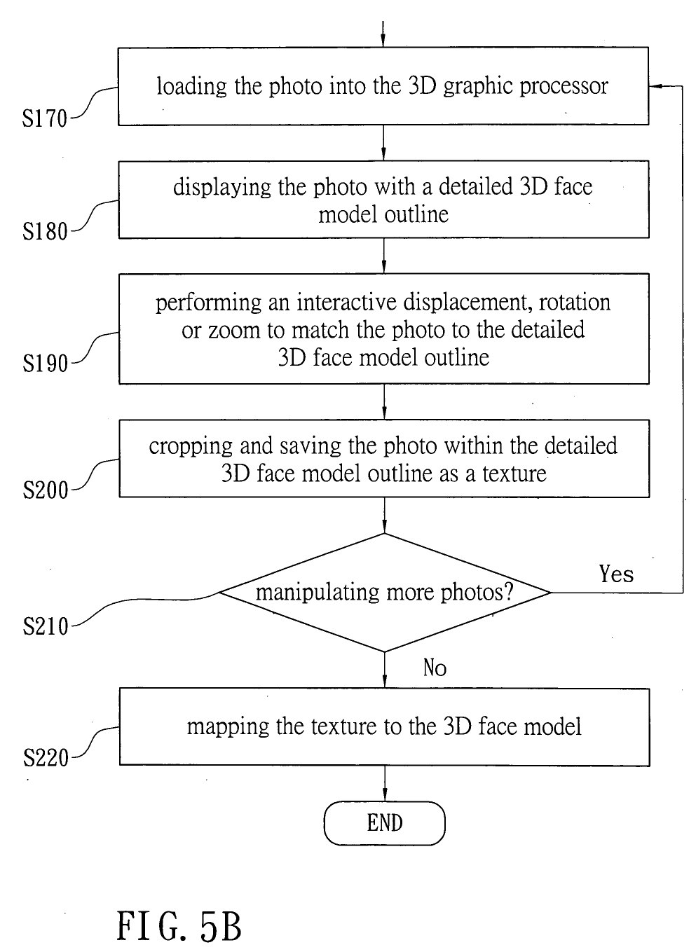

FIG. 5 is a flow chart showing the steps for a method for capturing 3D face of the present invention. The procedure first selects a 3D face model for a living object, as shown in step S100.

In step S110, a number of acquiring angles of the 3D face model are decided.

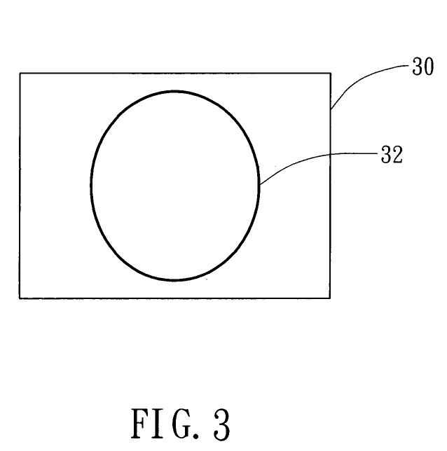

In step S120, as shown in FIG. 3, a rough outline of the model 32 selected is loaded and displayed on a preview display 30.

In step S130, a camera of a hand-held device is pointed to the living object.

In step S140, the camera of the hand-held device is moved to place the object face within the rough outline 32 displayed on the screen.

In step S150, a photo of the face is taken to the digital image system 102 and saved to the 3D graphic processor 104 or the storage device 108 when the face is placed within the outline.

In step S160, if more photos need to be acquired at different angles, the procedure goes back to step S120; otherwise the procedure goes to step S170.

In step S170, the photo of a first acquiring angle is loaded into the 3D graphic processor 104.

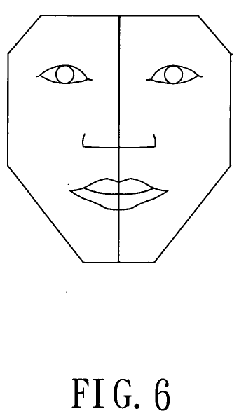

In step S180, the photo of the first acquiring angle is displayed by the display device 106 on the screen concurrently with a detailed 3D face model outline. The detailed 3D face model outline consists of a simple shape outline corresponding to the 3D face model and several registration points corresponding to the key features of the face, such as eyes, nose and mouth. An example of a detailed 3D face model outline for the 3D face model is shown in FIG. 6.

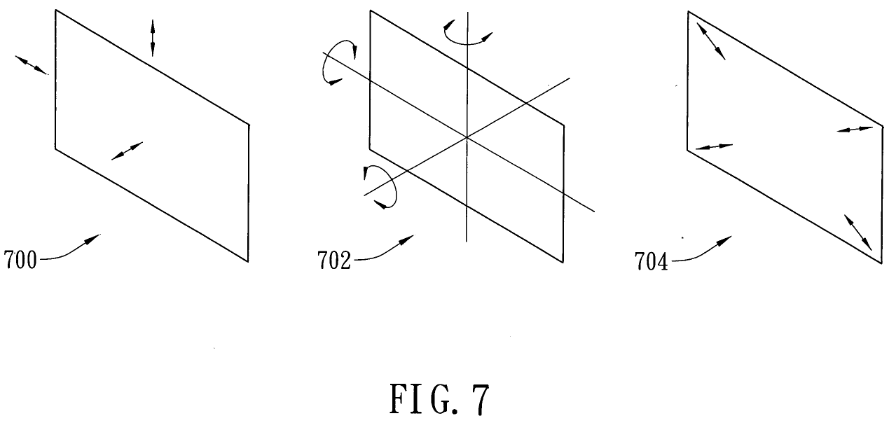

In step S190, as shown in FIG. 7, an interactive displacement 700, rotation 702 or zoom 704 is performed by the 3D graphic processor 104 to match the face photo to the model outline and the key feature registration points. FIG. 7 is a conceptual diagram for illustrating the displacement 700, rotation 702, and zoom 704 that are performed by the 3D graphic processor 104.

In step S200, the photo within the outline is cropped and saved to the 3D graphic processor 104 or the storage device 108 as the texture of the current angle when matching the outline and key registration points.

In step S210, if there are more photos for different angles, the procedure returns to step S170; otherwise, the procedure goes to step S220.

Finally, in step S220, the 3D graphic processor 104 maps the saved texture image(s) to the 3D face model to complete the 3D face acquisition.

Compared to the conventional system and method, the present invention has several advantages. First, since a 3D graphic processor is dedicated for the 3D face capturing system, the number of polygons manipulated and the number of frame rate are dramatically higher than the conventional CPU system. As a result, the 3D face capturing system has much better quality and is applicable to wide areas. Second, as the captured images are manipulated by the 3D graphic processor, the images can be easily adjusted to match the 3D model precisely, which reduced efforts of re-acquisition of the face images normally occurred in the conventional system. Third, due to the significant processing power of the 3D graphic processor, which is not feasible for the CPUs used in the conventional hand-held device. Therefore, by using the 3D graphic processor in the 3D face capturing system, a more realistic 3D face rendering result can be achieved than that of using CPUs. Finally, since in the system of this invention the image manipulation and 3D processing tasks are performed by the 3D graphic processor, the system does not require a powerful CPU as it does in the conventional system. Consequently, implementation costs and power consumptions can be reduced.

What is claimed is:

1. A system for capturing 3D face, applicable to a portable hand-help device, comprising:
a digital image system, for acquiring a photo;
a 3D graphic processor, for manipulating image data of the photo, rendering the image data to a 3D graph or storing the image data and the 3D graph; and
a display device, for displaying the image data or the 3D graph.

2. The system for capturing 3D face as recited in claim 1, further comprising a storage device for storing the photo, the image data and the 3D graph.

3. The system for capturing 3D face as recited in claim 1, further comprising a central processing unit for coordinating the system.

4. The system for capturing 3D face as recited in claim 1, wherein the 3D graphic processor is used for displacing, rotating, and zooming the photo.

5. The system for capturing 3D face as recited in claim 1, wherein the portable hand-help device is Digital Still Camera (DSC), Digital Video (DV), Personal Digital Assistant (PDA), mobile electronic device, 3G mobile phone, cellular phone or smart phone.

6. A method for capturing 3D face, applicable to a portable hand-help device, comprising the steps of:
selecting a 3D face model for a living object;
deciding a number of acquiring angles of the 3D face model;
loading and displaying a rough outline of the 3D face model on a display;
pointing a camera of the hand-held device to the living object;
moving the camera of the hand-held device to place a face of the living object within the rough outline;
taking and saving a photo of the face when the face is placed within the rough outline;
loading the photo of a first acquiring angle;
displaying the photo of the first acquiring angle with a detailed 3D face model outline;
performing an interactive displacement, rotation or zoom to match the photo to the detailed 3D face model outline;
cropping and saving the photo within the detailed 3D face model outline as a texture of the first angle when matching the detailed 3D face model outline; and
mapping the texture to the 3D face model.

7. The method for capturing 3D face as recited in claim 6, wherein if the decided acquiring angle(s) is multiple, the method repeats the step of loading and displaying the rough outline of the 3D face model and the following steps before the step of loading the photo of the first acquiring angle.

8. The method for capturing 3D face as recited in claim 6, wherein if more photos need to be manipulated, the method repeats the step of loading an added photo and the following steps before the step of mapping the texture to the 3D face model.

9. The method for capturing 3D face as recited in claim 6, wherein the detailed 3D face model outline is corresponding to key features of the face including eyes, nose and mouth.

10. The method for capturing 3D face as recited in claim 6, wherein the portable hand-help device is Digital Still Camera (DSC), Digital Video (DV), Personal Digital Assistant (PDA), mobile electronic device, 3G mobile phone, cellular phone or smart phone.
